(19) United States
(12) Patent Application Publication
(10) Pub. No.: US 2009/0272631 A1
(43) Pub. Date: Nov. 5, 2009

(54) Steerable conveyor with height adjustable wheels

(75) Inventor: Maurice Demong, Wakaw (CA)

Correspondence Address: Lipsitz & McAllister, LLC, 755 MAIN STREET, MONROE, CT, 06468, US

(73) Assignee: Prairie Machine & Parts Mfg.(1978) Ltd., Saskatoon (CA)

(21) Appl. No.: 12/459,505

(22) Filed: Jul. 1, 2009

Related U.S. Application Data
(63) Continuation of application No. PCT/CA2008/000244, filed on Feb. 7, 2008.

(30) Foreign Application Priority Data
Feb. 8, 2007 (CA) 2578432

(51) Int. Cl. B65G 41/00; B65G 15/00; B65G 21/10; E21F 13/00; B65G 37/00; B62D 13/04

(52) U.S. Cl. 198/804

(57) ABSTRACT

A steerable conveyor vehicle for use with an endless conveyor belt includes an elongate conveyor mechanism having two opposite side frame members. A pair of transversely aligned wheel units for supporting the conveyor are provided with each unit having a wheel support structure detachably connected to a respective side frame member and a wheel mounted to this structure for pivotable movement about a vertical axis. The wheel support structure includes a vertical support plate having a set of fastener holes formed therein. At least some of these holes are aligned with at least some fastener holes formed in the adjacent side frame member for connecting the wheel unit at a selected one of at least two possible relative heights.

This invention relates to conveyor systems and, in particular, conveyor vehicles for use with endless conveyor belts.

Belt conveyors are well known and are efficient means for moving large quantities of materials such as ore, coal and granular stone over a predetermined distance extending either horizontally, vertically or both. One form of conveyor system known for mining applications is a system involving a series of conveyors mounted on wheels so as to make the system easily movable. Because of the manner in which mines are developed and extended, it may be necessary for a relatively long conveyor system to be moved along a substantially curved or zig zag course. Under such circumstances, it can be difficult and time consuming to move the conveyor system when required. It will also be appreciated that it may be necessary to move the conveyor system and to make adjustments to the system fairly frequently as the mining machine advances in a mine.

U.S. Pat. No. 5,366,059 issued Nov. 22, 1994 to Prairie Machine & Parts Mfg. Ltd. describes and illustrates a conveyor system comprising a plurality of conveyor vehicles connected together in the form of a train and also describes a steering system for steering this train of vehicles. All but one of the vehicles in the train has a single pair of steerable wheels with the vehicle at the outby end of the train (that is the end to which the mine material is being delivered) having two steerable wheels. Hydraulic cylinders are used to steer each of the pairs of steerable wheels and there is a control mechanism for controlling and coordinating these cylinders in order to set the steering angles of the pairs of wheels. In this known system, each pair of wheels is mounted on an axle and each pair is driven by an electric tram motor mounted along the longitudinal centre of the conveyor vehicle. One difficulty encountered with this known conveyor system is that the system is relatively high along most of the length of the train and therefore the ceiling of the region of the mine where the mining machine is operating must be reasonably high, for example over six feet, to accommodate this conveyor system. Moreover, in this known system, the height of each pair of wheels relative to the conveyor frame is not adjustable.

There is a need in the belt conveyor industry to provide conveyor vehicles wherein the height of the wheels of the vehicle is adjustable and the wheels can be moved to a position which reduces the overall height of the conveyor vehicle. Alternatively, under some mining conditions where the mine area through which the conveyor system extends has a reasonably high ceiling, it can be desirable to adjust the wheels of each conveyor vehicle so that the height of the conveyor vehicle is increased, this increase having the advantage of increasing the ground clearance between the floor of the mine, which may be relatively rough and the conveyor mechanism supported by the wheels.

According to one aspect of the invention, a steerable conveyor vehicle for use as an endless conveyor belt includes a conveyor mechanism having two longitudinally extending side frame members and two opposite end sections between which the conveyor belt extends when mounted on the conveyor mechanism. Each side frame member has a first set of fastener holes formed therein. A pair of transversely aligned wheel units for supporting and moving the conveyor vehicle are also provided with each wheel unit having a wheel support structure detachably connected to a respective one of the side frame members and a wheel mounted to the wheel support structure for pivotable movement about a substantially vertical pivot axis for steering the vehicle. The wheel support structure includes a vertically extending support plate extending along and forming an inner side of the support structure and having a second set of fastener holes formed therein. At least some of the fastener holes of the second set are aligned with at least some of the fastener holes of the first set for connecting the respective wheel unit to its side frame member at a selected one of at least two possible relative heights provided by the first and second sets of fastener holes. Fasteners extend through aligned holes of the first and second sets and detachably connect the respective wheel unit to its side frame member. There is also provided a power steering system for steering the wheels of the wheel units.

In an exemplary embodiment of this vehicle, each wheel unit includes a hydraulic motor for rotating the wheel of the respective wheel unit, this hydraulic motor being pivotable with its wheel about the substantially vertical pivot axis.

According to another aspect of the invention, a conveyor vehicle includes a conveyor mechanism including an elongate, substantially horizontal frame, a series of conveyor roller devices mounted on the horizontal frame and adapted to support rotatably an upper run of a continuous conveyor belt extending between opposite end sections of the vehicle, a tail pulley unit mounted adjacent a first end of the conveyor mechanism on the horizontal frame and having a rotatable tail pulley, and a head pulley unit mounted adjacent a second end of the conveyor mechanism opposite the first end and having a rotatable head pulley. A motor mechanism is provided for moving the conveyor belt to transport material from the tail pulley to the head pulley. A pair of transversely aligned wheel units are provided to support and move the conveyor vehicle. Each of these units is separately connected to the horizontal frame on a respective longitudinally extending side thereof and each has a wheel mounted for pivotable movement about a substantially vertical pivot axis for steering purposes. Each wheel unit includes a non-rotating, wheel support structure adapted for detachably connecting the wheel unit to the horizontal frame. A power steering system is provided to steer the two wheels of the wheel units. There is also an aperture and fastener arrangement for mounting each wheel unit on its respective longitudinally extending side of the horizontal frame and for permitting the height of each wheel unit relative to the horizontal frame to be adjusted. The aperture and fastener arrangement includes a series of vertically spaced apart first apertures formed in each longitudinally extending side of the horizontal frame and further apertures formed in the wheel support structures and alignable with selected sets of the first apertures for connecting the wheel units to the horizontal frame at a desired relative height. The aperture and fastener arrangement also includes a plurality of fasteners insertable through a selected set of first apertures and the further apertures for rigidly connecting the wheel units to the horizontal frame.

In an exemplary embodiment, each wheel unit includes a hydraulic motor for rotating the wheel of the respective wheel unit.

These and other aspects of the disclosed conveyor vehicle will become more readily apparent to those having ordinary skill in the art from the following detail description taken in conjunction with the accompanying drawings.

In the drawings,

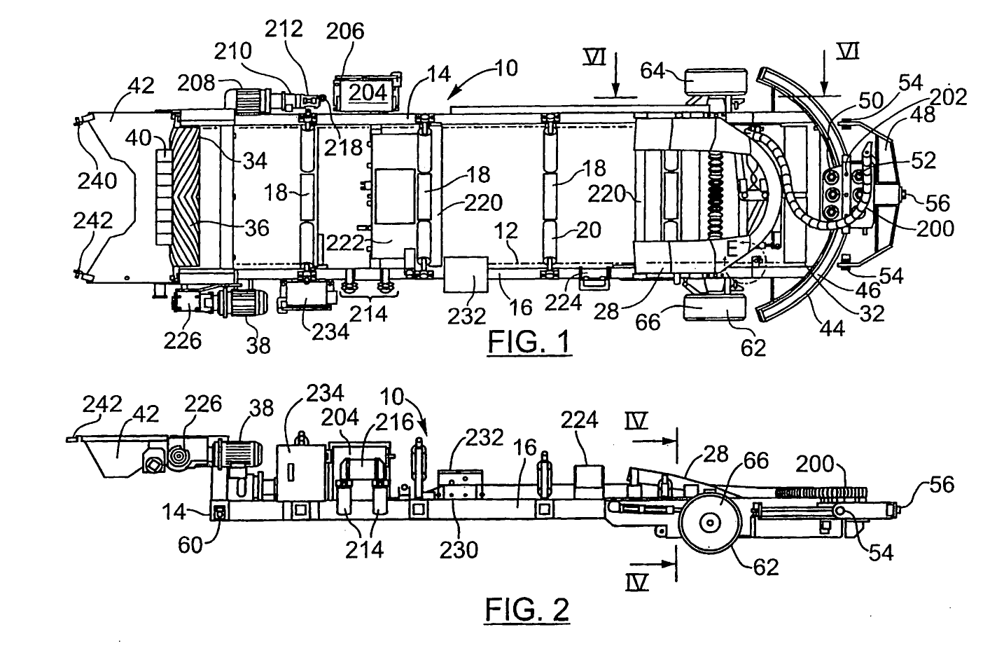

FIG. 1 is a top view of an exemplary embodiment of a low profile conveyor vehicle constructed in accordance with the invention;

FIG. 2 is a side elevation of the conveyor vehicle of FIG. 1;

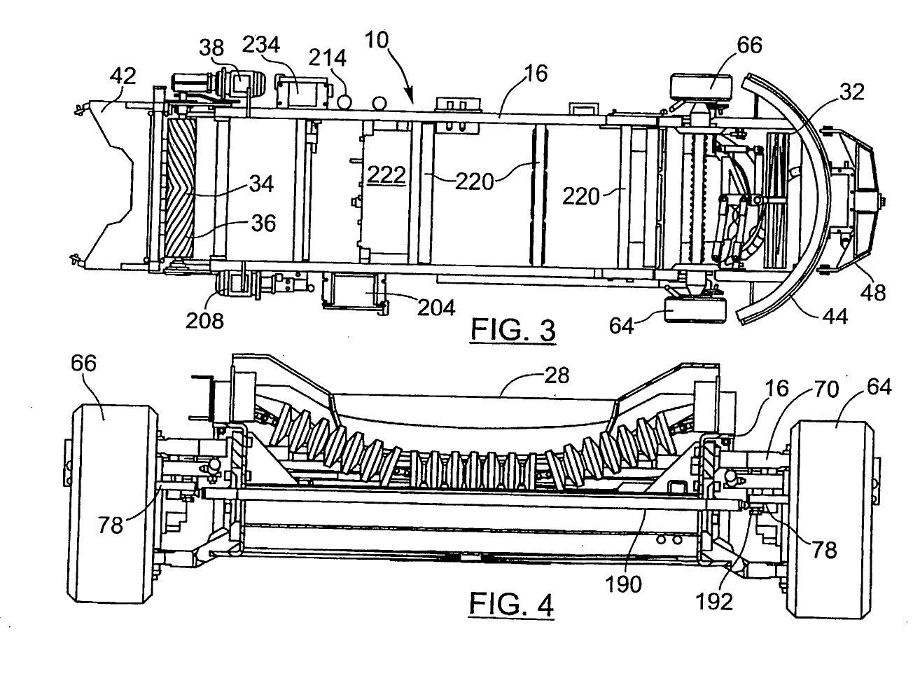

FIG. 3 is a bottom view of the conveyor vehicle of FIGS. 1 and 2;

FIG. 4 is a sectional elevation taken along the line IV-IV of FIG. 2;

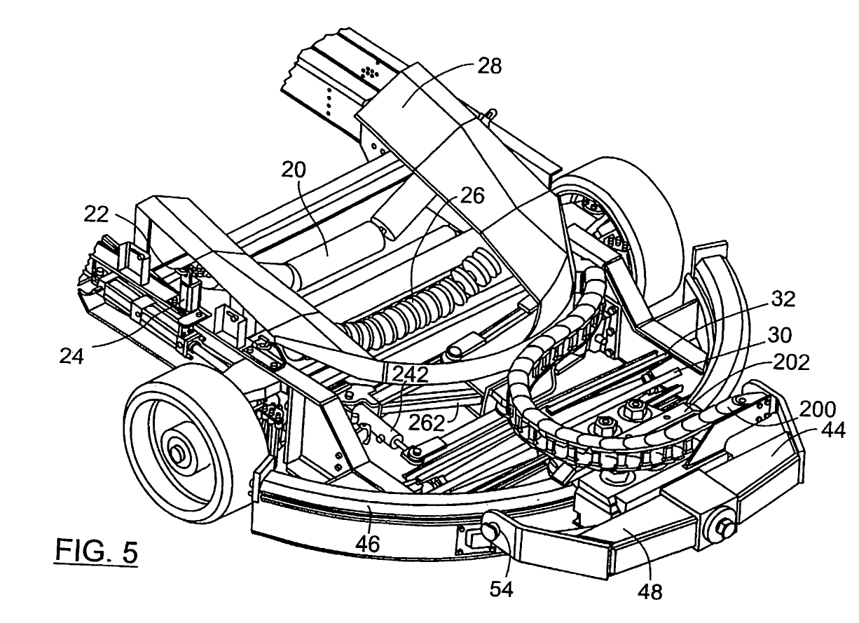

FIG. 5 is a perspective view taken from above and from the tail pulley end of the conveyor vehicle, this view showing an end section of the vehicle including its two wheels;

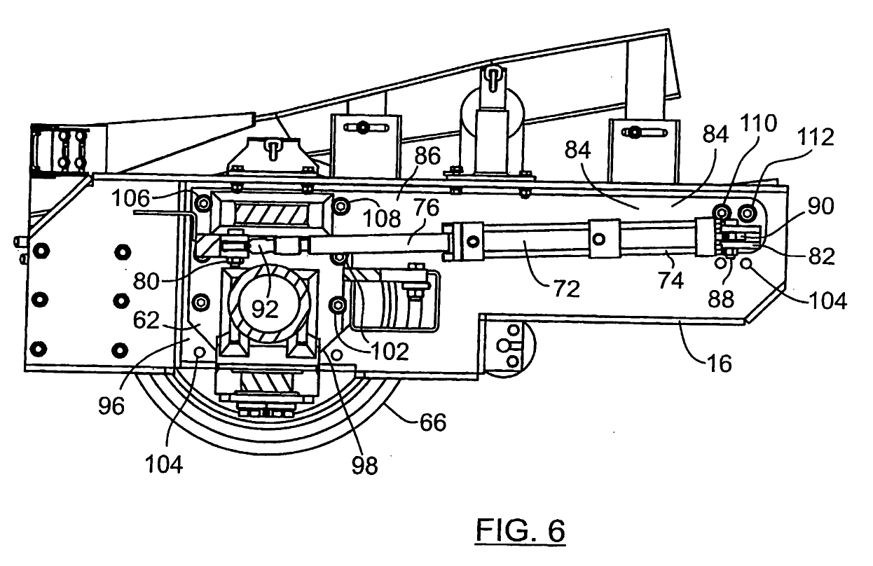

FIG. 6 is a sectional elevation taken along the line VI-VI of FIG. 1, this view showing details of the power steering arrangement for each wheel;

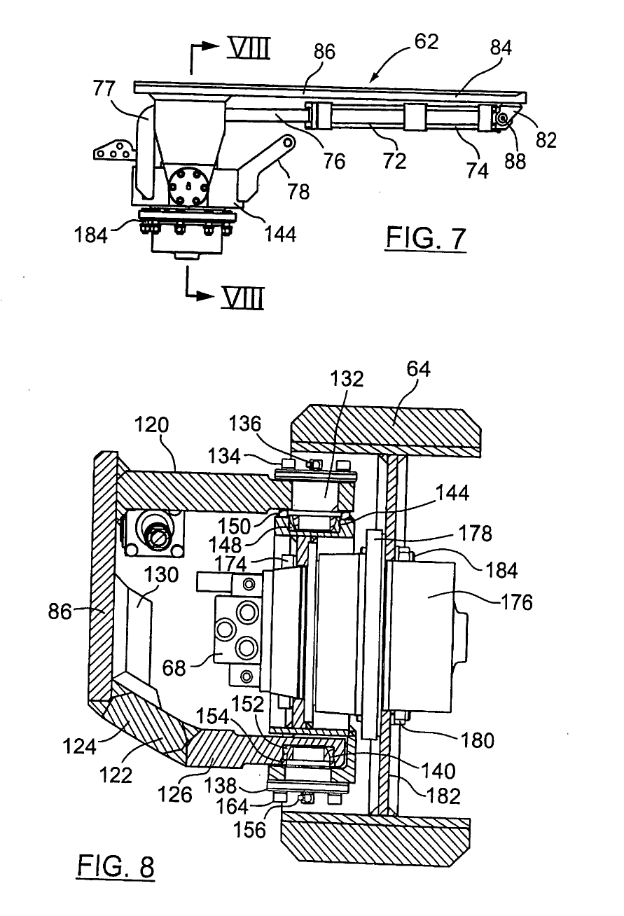

FIG. 7 is a detail top view of a left hand wheel unit assembly of the vehicle of FIGS. 1 and 2, this view omitting the wheel itself for sake of illustration;

FIG. 8 is a detail sectional elevation taken along the line VIII-VIII of FIG. 7;

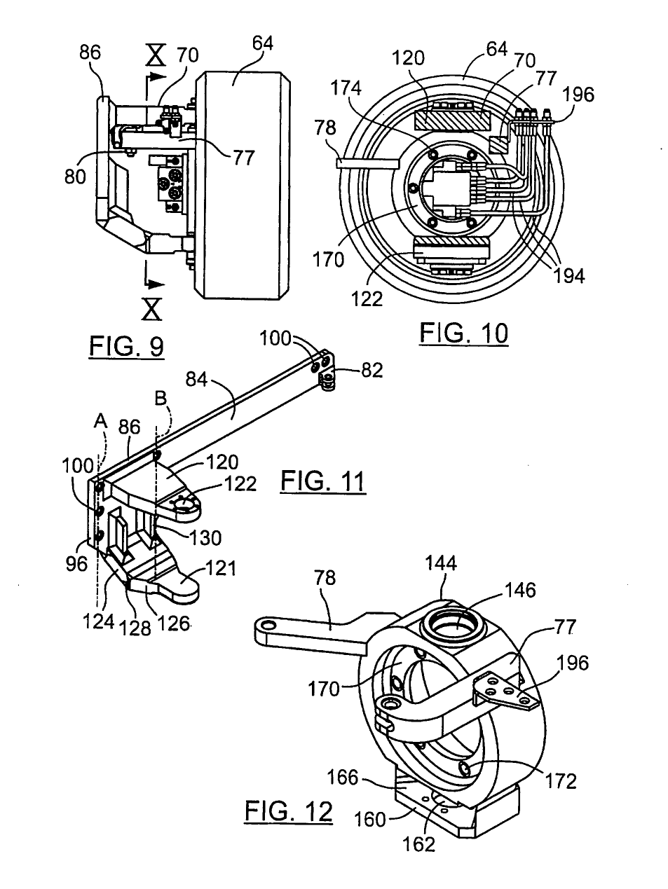

FIG. 9 is a detail end view of the wheel unit assembly of FIG. 7, this view being taken from the left side of FIG. 7 and showing the wheel mounted on the assembly;

FIG. 10 is a detail sectional elevation taken along the line X-X of FIG. 9;

FIG. 11 is a perspective detail view of a mounting plate weldment used to support each wheel and its hydraulic motor;

FIG. 12 is a detail perspective view illustrating a pivotable motor support member mounted adjacent each wheel;

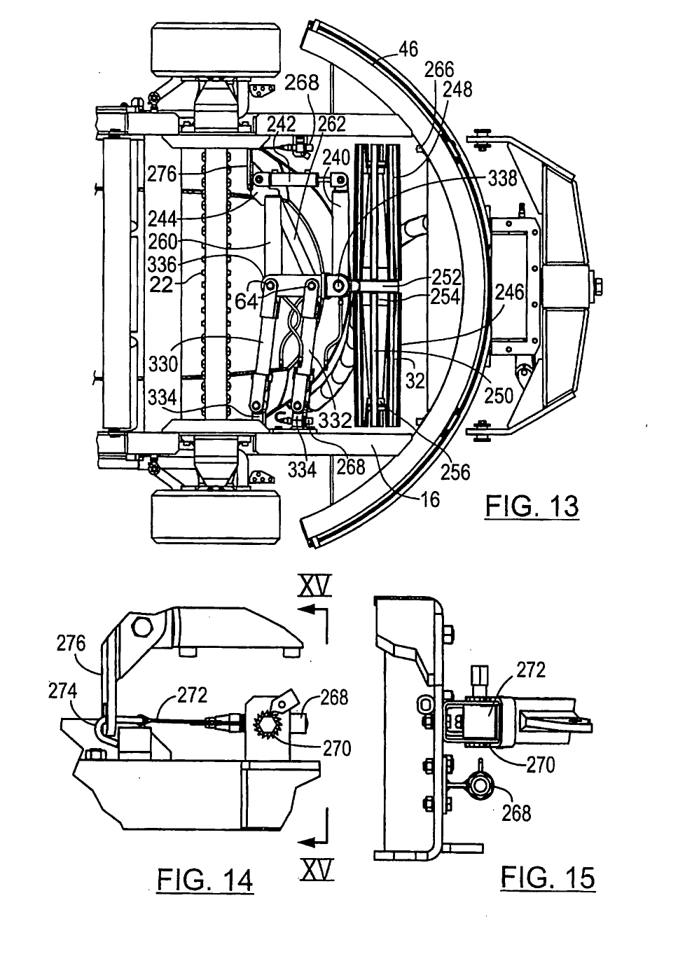

FIG. 13 is a partial bottom view of the conveyor vehicle showing the end section where the tail pulley is adjustably mounted;

FIG. 14 is a detail view of the circled area marked E in FIG. 1;

FIG. 15 is another detail view taken along the line XV-XV of FIG. 14; and

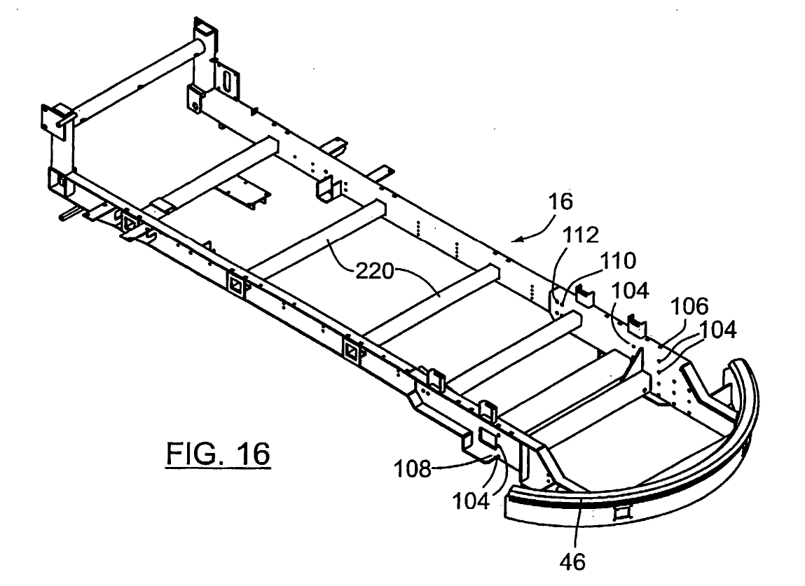

FIG. 16 is a perspective view of the main, elongate frame of the conveyor vehicle of FIG. 1.

Major components of a conveyor vehicle constructed in accordance with the invention are illustrated in FIGS. 1 to 5 of the drawings. The illustrated conveyor vehicle 10 has been shown without the usual flexible conveyor belt, the location of which is only indicated in chain-link lines in FIG. 1 for sake of illustration. This conveyor belt 12 is an endless conveyor belt and can be of standard construction depending upon the type of material being conveyed by the conveyor system. The illustrated exemplary vehicle is intended for use as an intermediate conveyor car of which there may be five, ten or more in a train of conveyor vehicles similar to the train illustrated and described in U.S. Pat. No. 5,366,059. It will be understood that in addition to a plurality of intermediate conveyor vehicles pivotably connected end-to-end, there is also provided a loading conveyor vehicle which is located at the end of the train adjacent the mining machine, and a discharge conveyor vehicle located at the opposite end of the train which is referred to as the outby end, that is, the end to which the train of vehicles delivers the material. As explained in U.S. Pat. No. 5,366,059, the loading car assembly can be constructed in a similar manner to the illustrated intermediate car assembly 10, except that it need not be provided with a hitch mechanism at its inby or hopper end, since there is no need to attach this end to another conveyor vehicle. As for the discharge conveyor vehicle, it is provided with two pairs of transversely aligned wheel units rather than a single pair of these wheel units described hereinafter. However, the wheel units on the discharge car can be constructed in the same manner as described hereinafter, including their steering mechanism and their hydraulic drive mechanism. The discharge car is also provided with a pivotable cross-conveyor for discharging the material onto a permanent or fixed conveyor in the mine. A cross-conveyor and its use is described and illustrated in U.S. Pat. No. 5,366,059. A detailed description of the discharge car and its cross-conveyor herein is deemed unnecessary as a cross-conveyor system is not considered an aspect of the present invention claimed herein.

Turning now to the illustrated conveyor vehicle 10, this vehicle has a conveyor mechanism 14 that includes an elongate, substantially horizontal frame 16 and a series of spaced apart conveyor roller devices 18 mounted on the horizontal frame 16 and adapted to support rotatably an upper run of the continuous conveyor belt 12 extending between opposite end sections of the vehicle. The roller devices 18 can be of standard construction available from conveyor parts suppliers. Each illustrated roller device comprises three metal rollers 20 which are pivotably connected together in an end-to-end fashion by their central shafts. The outer end of each outer roller is connected by a chain 22 (see FIG. 5) to a vertical support post 24 mounted on a main, longitudinally extending frame member of the main frame 16. The height of each pair of posts 24 varies as shown to gradually increase the height of the roller devices. In addition to the cylindrical, rotatable metal rollers 20, there can also be provided impact rollers 26 of known construction positioned below a U-shaped hopper member 28. It will be understood that the impact roller helps to absorb the impact of material dropping onto the conveyor belt at this location.

The conveyor mechanism 14 further includes a tail pulley unit mounted adjacent one end of the conveyor mechanism on the horizontal frame 16 and having a rotatable tail pulley indicated at 32. Further details of the construction of the tail pulley unit are provided hereinafter with reference to FIGS. 5 and 13 to 15. The conveyor mechanism 14 further includes a head pulley unit 34 mounted adjacent the second end of the conveyor mechanism opposite the first end where the tail pulley is located. The head pulley unit includes a rotatable head pulley 36 which, in a known manner, can be provided with a gripping cylindrical surface which enables the head pulley unit to drive the conveyor belt 12. There is also an electric motor mechanism 38 which can be considered part of the head pulley unit since it rotates the head pulley 36 to move the conveyor belt and thus to transport material from the tail pulley to the head pulley. A belt scraper 40 of known construction can be mounted adjacent to the head pulley to help keep the conveying surface of the belt clean. Mounted adjacent to the head pulley at the outby end of the vehicle is a material hopper 42 which helps direct the material onto the conveyor belt of the next conveyor vehicle. In order to provide a conveyor vehicle 10 having a low profile, there is provided a pivoting hitch mechanism 44 at the inby end of the vehicle. This hitch mechanism includes a curved steel track and a rolling hitch device 48 having two sets of grooved rollers located at 50 and 52 on two opposite V-shaped sides of the track 46. Two car hitch pins 54 are located on opposite sides of the hitch device 48 which is able to pivot about a central longitudinal axis of the vehicle by mean of central pivot pin 56. Located near the opposite head pulley end of the car are two pivot pin holders 60, one on each side of the frame 16.

The conveyor vehicle 10 has a pair of transversely aligned wheel units indicated generally at 62 for supporting and moving the conveyor vehicle. Each of these wheel units is separately connected to the horizontal frame 16 including any extension thereof. In particular, each wheel unit is connected to a respective longitudinally extending side of the frame. Each wheel unit has its own solid wheel with the wheel on the left side indicated at 64 and the wheel on the right hand side indicated at 66. As explained more fully hereinafter, each wheel 64, 66 is mounted for pivotable movement about a substantially vertical pivot axis for steering purposes, that is, to steer the vehicle 10. In an exemplary embodiment of the conveyor vehicle, each wheel unit includes a standard hydraulic motor 68 shown clearly in FIG. 8. This motor is used to rotate or drive the wheel of the respective wheel unit. Also, each wheel unit includes a non-rotating wheel support structure indicated generally at 70 for detachably connecting the wheel unit to the horizontal frame, including any extension of this frame. The left hand wheel unit 62, with its wheel removed, is illustrated in FIG. 7 and is illustrated with its wheel in FIGS. 8 and 9. FIG. 7 also shows a power steering mechanism or power steering means 72 for steering the wheel of this wheel unit. The illustrated power steering mechanism includes a hydraulic linear actuator having a hydraulic cylinder 74 and an actuator rod 76 slidable in the cylinder. A steering arm 77 having a L-shape is rigidly attached at one end to an upper section of a motor support member 144 (see FIG. 12) and is pivotably connected at its other end to the rod 76 by means of a bolt and nut 80 (see FIG. 9). The closed end of cylinder 74 is pivotably mounted by means of lugs 82 to an end of a horizontally extending, elongate arm section 84 which is part of a wheel unit mounting plate 86. A nut and bolt combination 88 pivotably connects a short connecting plate 90 that is rigidly attached to the end of the cylinder to the lugs 82. The actuator rod 76 can be provided with a spherical bearing 92 that is connected by threads to the outer end of the rod. This bearing is connected to the steering arm 77 by the nut and bolt 80.

In addition to the arm section 84, the flat mounting plate 86 includes a main plate portion 96 shown in FIG. 6. This main plate portion has a generally rectangular shape except for cut-off bottom corners 98. The arm section 84 extends horizontally from an upper corner of the main plate portion 96. An advantage provided by the arm section 84 is that the hydraulic cylinder can then be pivotably mounted to the same mounting plate 86 as the wheel and its hydraulic motor 68. As can be seen from FIGS. 6 and 11, each wheel unit 62 and, in particular its mounting plate 86 (which is part of the wheel support structure), is formed with a plurality of apertures or holes indicated generally by reference 100 which are provided to receive fasteners, preferably bolts, used to attach the respective wheel unit to the frame 16, including any extension thereof. A plurality of fasteners 102 for this purpose are shown in FIG. 6. It will be understood that these fasteners are insertable through spaced-apart apertures 104, four of which can be seen in FIG. 6 and more are shown in FIG. 16. There are a plurality of the apertures 104 formed in each longitudinally extending side of the frame 16 and optionally additional apertures can be provided in extension plates attachable to the main frame members. As illustrated, the apertures 104 form a first vertical row located at 106, a second vertical row located at 108, a third vertical row located at 110 and a fourth vertical row located at 112, with the latter two rows being shorter than the first two rows. In particular, in the illustrated vehicle, there are four apertures 104 in the first row at 106 and four apertures in the second row 108, while there are only two apertures in each of the third and fourth rows. The apertures 100 formed in the mounting plate 86 are located in opposite end sections of the mounting plate as clearly shown in FIG. 11. The apertures 100 as illustrated are arranged in a first vertical row indicated by the dashed line A and in a second vertical row indicated by the dashed line B in the main plate portion 96 and also at the distal end of the arm section 84, that is the end spaced from the main plate portion. As illustrated, there are two holes 100 for fasteners at the end of the arm section and these can be arranged side-by-side in the horizontal direction and above the connecting lugs 82. The illustrated aperture arrangement permits the height of each wheel unit relative to the horizontal frame 16 to be adjusted between either one of two possible positions, but it will be appreciated by those skilled in the art that by providing further apertures 104, for example, on each longitudinal frame member or an extension plate, it is possible to provide for more than two possible height positions for each wheel unit, for example, three, four or more. In the position of the wheel units illustrated in FIG. 6, the wheel units 62 are at their maximum height relative to the frame 16. In this position, the overall height of the conveyor vehicle will be a minimum height which, in an exemplary embodiment, is only four feet or forty-eight inches as compared to earlier conveyor vehicles such as those described and illustrated in U.S. Pat. No. 5,366,059 which had an overall height of six feet or seventy-two inches. In this position of the wheel units in the exemplary embodiment, the ground clearance provided under the vehicle is six inches. However, in the event that mining conditions require greater ground clearance and provided the mine area has an adequate ceiling or working height for the conveyor system, the wheel units can be moved to the second position which in the exemplary embodiment provides an additional four inches of ground clearance for a total of ten inches. In this case, the overall height of the conveyor vehicle is fifty-two inches.

In the second position, it will be understood that the lowermost hole in row A of the mounting plate 86 is aligned with the lowermost hole 104 in the corresponding vertical row formed in the longitudinal frame member. At the same time, in this lowered position, the two holes 100 of the mounting plate 86 located at the end of the arm section will be aligned with the two bottom holes 104 visible under the lugs 82 in FIG. 6.

Turning now to the remainder of the wheel support structure 70, as clearly shown in FIGS. 8 and 11, the wheel support structure includes upper and lower, horizontally extending wheel supporting arms 120, 122, both with rounded distal ends. The upper arm 120 can be formed from a single steel plate welded to the top of mounting plate 86 and is formed with a round hole 122 to receive an upper pivot pin member. As illustrated, the lower support arm 122 can be constructed of two short plate members 124, 126 which are welded together at 128 and which extend at an obtuse angle to one another as shown in FIG. 8. The strength and rigidity of the connection between the sloping plate 124 and plate 86 can be strengthened by two vertically extending gussets 130 which are welded to these plates. A top pivot pin 132 is mounted in the hole 122 and is connected to the upper arm 120 by six screws 134. The pivot pin can be provided with a central passageway (not shown) that extends downwardly from grease zerk 136. There is also a bottom pivot pin 138 having a reduced top end extending into a circular recess 140 formed in the rounded end section of the lower support arm 122.

In order to pivotably support the wheel and its hydraulic motor 68, there is provided a substantially annular motor support member 144 shown in FIG. 12. This support member has a circular recess 146 formed on its top side and into this recess a reduced bottom end section of the top pivot pin 132 extends. Mounted in this recess is a spherical angular contact bearing 148 which, in one embodiment, has a bore measuring 1¾″ and has an outside diameter of 2 13/16 inch. Protecting this bearing and extending around the top edge of the bearing is a suitable seal such as a Chesterton Super Wiper seal 150. Similarly, extending around a reduced upper portion of the bottom pivot pin is a spherical angular contact bearing 152 which is sealed by means of a Chesterton super wiper seal 154. The bottom pivot pin can be greased through grease zerk 156.

Returning to FIG. 12, it will be seen that the motor support member 144 has a bottom extension 160 which is welded to the annular portion of the support member 144 and which has a circular hole 162. The bottom pivot pin projects through the hole 162 from the bottom and is detachably connected to the extension 160 by six screws 164 which extend through a flange extending around the bottom of this pivot pin. Formed between the extension 160 and the annular portion of support member 144 is a cavity 166 which receives the rounded end portion of the horizontal plate 126. In this way, the support member 144 is pivotably supported from below.

It can also be seen from FIG. 12 that the support member 144 has a radially inwardly extending connecting flange 170, this flange being formed with a series of fastener holes 172. As shown in FIG. 10, six screws 174 can be used to attach the hydraulic motor 68 to the flange 170 along with its associated planetary gear box 176. The planetary gear box has an annular rotating flange 178 which is attached by nine hex nuts 180 to a circular plate 182 forming a central portion of the hub of the wheel. The nuts are threaded onto studs 184 visible in FIG. 7, these studs extending through the rotating flange on the gear box. It is understood that the left and right wheels 64, 66 are solid rubber wheels and, in one embodiment, each wheel measures 10″×24″ in diameter. The left and right wheels 64, 66 are connected by a steering tie rod 190 shown in FIG. 4 which ensures that the wheels pivot in the same way at the same time. It is connected at each end to the tie rod arm 78 of the respective wheel by means of a bolt with a nylon insert lock nut 192.

It will be understood that the hydraulic motor for each wheel unit is provided with pressurized hydraulic fluid through hydraulic lines and fittings of standard construction which are readily available and well known in the art. Most of these lines are not shown for ease of illustration. Some of these lines are indicated at 194 in FIG. 10. Connecting fittings for these lines can be supported by a small bracket 196 shown in FIG. 12. It will be understood that the hydraulic motor itself and its gear box are of standard construction and accordingly a detailed description herein is deemed unnecessary.

Various other features in the illustrated exemplary low profile conveyor vehicle that are shown in FIGS. 1 to 3 include a plastic energy chain 200 through which electrical cables and wires are fed for the operation of the vehicle and an energy chain guide 202 which helps to support the movement of the energy chain. Mounted to the frame on the left side is an electrical power box 204 of standard construction, this box having an access door 206. Mounted to the same side of the frame is an electric motor 208 which powers first and second hydraulic pumps 210 and 212, the first pump 210 being used to drive the hydraulic motors for the wheels and the second pump 212 being used to power other hydraulic components on the vehicle. Two standard filters for the hydraulic system are provided at 214 on the right side of the vehicle. Mounted above these filters is a junction box 116. A third hydraulic filter can be provided at 218 adjacent the pump 212. On or between the two longitudinal main frames of the frame 16 and adjacent one of the cross-frames 220 is a hydraulic fluid reservoir 222. Another junction box for electrical components including connectors is provided on the right side at 224. The side mounted electrical motor 38 for the head pulley is connected to a conveyor gear box 226 which has an output shaft connected to the shaft of the head pulley. In one embodiment, the motor 38 is a 7.5 kwatt or 10 hp motor. Also on the right side of the vehicle there is mounted to the longitudinal frame member a hydraulic assembly manifold 230 which is protected by a shroud or guard 232. On the same side of the frame near the motor 38 is a control box containing a programmable logic controller for controlling the operation and steering of the vehicle, the box indicated at 234. In a known manner, the vehicle 10 can also be provided with water sprayers, two of which are indicated at 240, 242. Water hoses (not shown) are connected to the sprayers to reduce dust levels generated by the conveyor system.

Turning now to the mounting mechanism for the tail pulley 32, this mounting system as seen most clearly in FIG. 13 includes two parallel links or swing arms 330 and 332 which are pivotably mounted on pivot pin sleeves 334 fixedly mounted on the inside of the frame 16. The inner ends of the links are located along the longitudinal centreline of the car and are pivotably connected to central mounting frame 336 which provides support for a substantially vertically extending pivot pin 338. Pivotably connected to this pin is a belt control arm 240 which in turn is pivotably connected to the actuator rod of a belt training hydraulic cylinder 242. The closed end of this cylinder is pivotably connected to an adjustable horizontal support plate 244.

The tail pulley itself comprises two rotatable pulley sections 246 and 248 which rotate about a non-rotating central support shaft (not shown) located at 250 that extends from opposite sides of a central, circular support block 252 rigidly connected to one end of the control arm 240. Mounted on opposite sides of the support block are two central bearings located at 254, each rotatably supporting a respective one of the pulley sections 246, 248. In a known manner, the exterior of these pulley sections comprises a series of parallel, spaced-apart metal slats, the inner ends of which are mounted on an annular support member containing the central bearing unit. An outer bearing located at 256 is also mounted on the outer end of each section of the shaft 50 to support the outer end of the respective pulley section. Horizontally extending frame members 260, 262 are fixedly connected to the central frame 336 and are also connected to the plate 244. These frame members are used to apply the required horizontal force to the tail pulley to tension same for operation.

The position of the tail pulley can be adjusted for belt training purposes either manually using the hydraulic cylinder 242 and a hydraulic container or automatically. In order to provide an optional automatic adjustment system for correcting the position of the conveyor belt, a photosensor system can be provided at each end of the tail pulley. As illustrated, there are two photoemitters 266 mounted on the curved track 46. For each of these photoemitters there is a photoreceiver 268 which can be seen in FIGS. 13 to 15. As long as the conveyor belt is properly centered on the tail pulley, pulses of a light beam can travel from each photoemitter 266 (through the gaps in the adjacent pulley section) to its respective photoreceiver which is mounted on the inside of one of the longitudinal frame members forming the frame 16. However, if the belt moves transversely on the tail pulley so as to block entirely one of the light beams, this provides a control signal to a programmable logic controller which in turn causes retraction or extension of the actuator rod of the hydraulic cylinder 242. The actuator rod will move in a direction so as to cause the central shaft of the tail pulley to be pivoted in a horizontal plane so as to tighten the belt on the side to which the belt has moved. This will tend to cause the belt to move back towards its center position.

As indicated, in an exemplary version of the belt adjustment system, each photosensor is aligned with the end section of the tail pulley so that the light beam is regularly broken by the parallel slats on the exterior of the tail pulley. Because of this arrangement, each photoreceiver sends a pulse signal to the programmable logic controller when the belt is not entirely blocking the light beam. Thus, if the belt is properly centered, pulse signals are being sent to the controller by both photoreceivers 268. When a pulse signal is not being emitted by one of the light receivers, then this indicates that the belt has moved too much in the direction of this particular receiver and the control system will take steps to re-center the belt. Note also that this set-up also provides a conveyor shut-down feature which will be triggered when both photoreceivers are not sending a pulse signal to the programmable logic controller. The lack of a pulse signal from both receivers indicates that the tail pulley is not rotating and therefore the conveyor belt itself is not moving. The control system for the conveyor car train is set up to shut down all of the conveyor cars in the event that one or more of the conveyor belts is not moving.

Another feature employed by the tail pulley system is illustrated in part in FIGS. 14 and 15. Extending from a small winch 270 is a two inch wide nylon strap 272, a rolled section of which can be seen in FIG. 15. The winch and strap are positioned above the photoreceiver 268 and are mounted on the inside of the main frame 16 of the vehicle. The strap extends to a metal hook 274 shown in FIG. 14, this hook extending through a hole formed in the end of a vertical connecting plate 276. The plate 276 is rigidly connected to one edge of the horizontal plate 244. It will be appreciated that once the conveyor belt is mounted in place and extends around the tail pulley (as well as the head pulley) the conveyor belt can be tensioned properly by pulling on the strap 272 which in turn will cause the frame members 260, 262 and the central frame 336 to move in a direction towards the tail pulley end of the vehicle.

While the present invention has been illustrated and described as embodied in an exemplary embodiment, ie. an embodiment having particularly utility for use as a low profile, mobile conveyor vehicle suitable for use with other similar conveyor vehicles, it is to be understood that the present invention is not limited to the details shown herein, since it will be understood that various omissions, modifications, substitutions and changes in the forms and details of the disclosed conveyor vehicle and its method of operation may be made by those skilled in the art without departing in any way from the spirit and scope of the present invention. For example, those of ordinary skill in the conveyor art will readily adapt the present disclosure for various other conveyor applications without departing from the spirit and scope of the present invention.

1. A conveyor vehicle comprising:
a conveyor mechanism including an elongate, substantially horizontal frame, a series of conveyor roller devices mounted on said horizontal frame and adapted to support rotatably an upper run of a continuous conveyor belt extending between opposite end sections of the vehicle, a tail pulley unit mounted adjacent a first end of said conveyor mechanism on said horizontal frame and having a rotatable tail pulley, a head pulley unit mounted adjacent a second end of said conveyor mechanism opposite said first end and having a rotatable head pulley, and motor means for moving said conveyor belt to transport material from said tail pulley to said head pulley;
a pair of transversely aligned wheel units for supporting and moving said conveyor vehicle, each separately connected to said horizontal frame on a respective longitudinally extending side thereof, each having a wheel mounted for pivotable movement about a substantially vertical pivot axis for steering purposes, and each including a non-rotating, wheel support structure adapted for detachably connecting the wheel unit to said substantially horizontal frame;
a power steering system for steering the two wheels of said wheel units;
an aperture and fastener arrangement for mounting each wheel unit on its respective longitudinally extending side of the substantially horizontal frame and for permitting the height of each wheel unit relative to said substantially horizontal frame to be adjusted, said aperture and fastener arrangement including a series of vertically spaced-apart first apertures formed in each longitudinally extending side of the substantially horizontal frame, further apertures formed in the wheel support structures and alignable with selected sets of said first apertures for connecting said wheel units to said substantially horizontal frame at a desired relative height, and a plurality of fasteners insertable through a selected set of first apertures and said further apertures for rigidly connecting said wheel units to said horizontal frame.

2. A conveyor vehicle according to claim 1 wherein each wheel unit includes a hydraulic motor for rotating the wheel of the respective wheel unit.

3. A conveyor vehicle according to claim 2 wherein said power steering system includes a hydraulic linear actuator for each wheel having a hydraulic cylinder and an actuator rod slidable in said cylinder, and a steering arm fixedly connected to a pivotable motor support member connected to said hydraulic motor and pivotably connected to said actuator rod.

4. A conveyor vehicle according to claim 1 wherein each wheel support structure includes a wheel unit mounting plate with a horizontally extending, elongate arm section, and wherein said further apertures are formed in the two wheel unit mounting plates and are located in opposite end sections of each wheel unit mounting plate.

5. A conveyor vehicle according to claim 3 wherein each wheel support structure includes a wheel unit mounting plate with a horizontally extending, elongate arm section and wherein said hydraulic cylinder of the linear actuator is pivotably connected to said arm section.

6. A conveyor vehicle according to claim 5 wherein said further apertures are formed in the two wheel unit mounting plates, each of which has a main plate portion located axially inwardly from its respective wheel and an elongate arm section, and said further apertures are arranged in two vertical rows in said main plate portion and at an end of said elongate arm section spaced from its respective main plate portion.

7. A conveyor vehicle according to claim 2 wherein each wheel support structure includes upper and lower, horizontally extending wheel supporting arms, two pivot pins each arranged in a respective one of said wheel supporting arms so that the two pins are aligned with and provide said substantially vertical pivot axis, and a generally annular support member in which said hydraulic motor is mounted, said two pivot pins pivotably connecting said annular support member to the upper and lower wheel supporting arms.

8. A steerable conveyor vehicle for use with an endless conveyor belt, said vehicle comprising:
a conveyor mechanism having two side frame members and two opposite end sections between which said conveyor belt extends when mounted on said conveyor mechanism, each side frame member having a first set of fastener holes formed therein;
a pair of transversely aligned wheel units for supporting and moving said conveyor vehicle, each wheel unit having a wheel support structure detachably connected to a respective one of said side frame members and a wheel mounted to said wheel support structure for pivotable movement about a substantially vertical pivot axis for steering the vehicle, said wheel support structure including a vertically extending support plate extending along and forming an inner side of the support structure and having a second set of fastener holes formed therein, at least some of said fastener holes of the second set being aligned with at least some of the fastener holes of the first set for connecting the respective wheel unit to its side frame member at a selected one of at least two possible relative heights provided by the first and second sets of fastener holes;
fasteners extending through aligned holes of the first and second sets and detachably connecting the respective wheel unit to its side frame member; and
a power steering system for steering the wheels of said wheel units.

9. A steerable conveyor vehicle according to claim 8 wherein each wheel unit includes a hydraulic motor for rotating the wheel of the respective wheel unit, said hydraulic motor being pivotable with its wheel about said substantially vertical pivot axis.

10. A steerable conveyor vehicle according to claim 8 wherein said power steering system includes a hydraulic linear actuator for each wheel having a hydraulic cylinder and an actuator rod slidable in said cylinder, and further includes a steering arm pivotably connected to said actuator rod and fixedly connected to a central, non-rotating, pivoting support member of said wheel support structure, and wherein said power steering system in use is able to pivot said central pivoting support member about said substantially vertical pivot axis in order to steer its respective wheel.

11. A steerable conveyor vehicle according to claim 10 wherein said vertically extending support plate includes a main plate portion located inwardly from and adjacent its respective wheel and a horizontally extending arm section connected to a side edge of the main plate portion and wherein said hydraulic cylinder is pivotably connected to and mounted on said arm section.

12. A steerable conveyor vehicle according to claim 11 wherein said second set of fastener holes includes two vertical rows of holes formed in the main plate portion and at least one hole formed in said arm section.

13. A steerable conveyor vehicle according to claim 8 wherein said wheel support structure includes upper and lower, horizontally extending arm members fixedly connected to said vertically extending support plate and projecting outwardly therefrom and two pivot pins each arranged in a respective one of said wheel supporting arm members so that the two pins are aligned with and provide said substantially vertical pivot axis.

14. A steerable conveyor vehicle according to claim 9 wherein said wheel support structure includes upper and lower, horizontally extending arm members fixedly connected to said vertically extending support plate and projecting outwardly therefrom and two pivot pins each arranged in a respective one of said wheel supporting arms so that the two pins are aligned with and provide said substantially vertical pivot axis and further includes a substantially annular motor support member extending around and fixedly connected to said hydraulic motor, and wherein said pivot pins pivotably connect said motor support member to said upper and lower arm members.

15. A steerable conveyor vehicle according to claim 8 wherein said pair of wheel units are the only wheel units on said conveyor vehicle which is adapted for connection to and use with other conveyor vehicles to form a conveyor train, said conveyor mechanism includes a tail pulley and a driven head pulley for said conveyor belt, and said pair of wheel units are located adjacent one of said end sections of the conveyor mechanism, said one end section being where the tail pulley is mounted.

16. A conveyor vehicle according to claim 2 wherein each wheel support structure includes a wheel unit mounting plate with a horizontally extending, elongate arm section, and wherein said further apertures are formed in the two wheel unit mounting plates and are located in opposite end sections of each wheel unit mounting plate.

17. A conveyor vehicle according to claim 4 wherein each wheel support structure includes upper and lower, horizontally extending wheel supporting arms, two pivot pins each arranged in a respective one of said wheel supporting arms so that the two pins are aligned with and provide said substantially vertical pivot axis, and a generally annular support member in which said hydraulic motor is mounted, said two pivot pins pivotably connecting said annular support member to the upper and lower wheel supporting arms.

18. A steerable conveyor vehicle according to claim 9 wherein said wheel support structure includes upper and lower, horizontally extending arm members fixedly connected to said vertically extending support plate and projecting outwardly therefrom and two pivot pins each arranged in a respective one of said wheel supporting arm members so that the two pins are aligned with and provide said substantially vertical pivot axis.

19. A steerable conveyor vehicle according to claim 12 wherein said wheel support structure includes upper and lower, horizontally extending arm members fixedly connected to said vertically extending support plate and projecting outwardly therefrom and two pivot pins each arranged in a respective one of said wheel supporting arm members so that the two pins are aligned with and provide said substantially vertical pivot axis.

20. A steerable conveyor vehicle according to claim 14 wherein said pair of wheel units are the only wheel units on said conveyor vehicle which is adapted for connection to and use with other conveyor vehicles to form a conveyor train, said conveyor mechanism includes a tail pulley and a driven head pulley for said conveyor belt, and said pair of wheel units are located adjacent one of said end sections of the conveyor mechanism, said one end section being where the tail pulley is mounted.
